(19) United States
(12) Patent Application Publication
(10) Pub. No.: US 2026/0187190 A1
(43) Pub. Date: Jul. 2, 2026

(54) METHOD AND DEVICE OF BIT-LEVEL-SPARSITY-BASED ANALOG-MIXED-SIGNAL IN-MEMORY MATRIX-VECTOR MULTIPLICATION WITH ROBUST ERROR CHARACTERISTICS, HIGH ENERGY EFFICIENCY, AND HIGH COMPUTATIONAL SPEED

(71) Applicants: Korea Advanced Institute of Science and Technology, Daejeon (KR); University-Industry Cooperation Group of Kyung Hee University, Gyeonggi-do (KR)

(72) Inventors: Minkyu JE, Daejeon (KR); Donghyeon YI, Daejeon (KR); Jongho KIM, Daejeon (KR); Junyoung KIM, Daejeon (KR); SeoYoung LEE, Daejeon (KR); Ik-Joon CHANG, Gyeonggi-do (KR)

(73) Assignees: Korea Advanced Institute of Science and Technology, Daejeon (KR); University-Industry Cooperation Group of Kyung Hee University, Gyeonggi-do (KR)

(21) Appl. No.: 19/436,826

(22) Filed: Dec. 30, 2025

(30) Foreign Application Priority Data
Dec. 31, 2024 (KR) 10-2024-0201532
Dec. 2, 2025 (KR) 10-2025-0188123

(51) Int. Cl. G06F 17/16; G06F 12/02

(52) U.S. Cl. CPC G06F 17/16; G06F 12/0207

(57) ABSTRACT

Disclosed are a method and a device for bit-level sparsity-based analog-mixed-signal (AMS) in-memory matrix-vector multiplication with robust error characteristics, high energy efficiency, and high computational speed, which may be configured to detect the number of logical value ‘1’s within an input vector, to reconstruct the input vector into a plurality of partial input portions each including a preset number of logical value ‘1’s, based on the detected number, to activate wordlines equal to or less than the preset number in a memory array, and apply the partial input portions to the activated wordlines, and to perform a matrix-vector multiplication operation based on a current response of the memory array.

### CROSS-REFERENCE TO RELATED APPLICATION(S)

This application claims the priority benefit of Korean Patent Application Nos. 10-2024-0201532, filed on Dec. 31, 2024 and 10-2025-0188123, filed on Dec. 2, 2025, in the Korean Intellectual Property Office, the disclosure of which is incorporated herein by reference.

### BACKGROUND

### 1. Field of the Invention

The present disclosure relates to a method and a device for bit-level sparsity-based analog-mixed-signal (AMS) in-memory matrix-vector multiplication with robust error characteristics, high energy efficiency, and high computational speed.

### 2. Description of the Related Art

Deep neural networks (DNNs) have demonstrated remarkable performance in various fields, including computer vision and natural language processing. However, their processing on the conventional Von-Neumann architecture causes significant performance and energy overhead due to large data traffic between processing units and memory. Analog-mixed-signal (AMS) compute-in-memory (CIM) systems (AMS-CIM systems) have emerged as a potential solution to solve this issue. The AMS-CIM systems may perform analog multiply-and-accumulate (MAC) operations on memory arrays by activating a plurality of memory wordlines (WLs). This approach reduces performance and power overhead due to the data traffic, making it an attractive alternative to the Von-Neumann architecture.

While initial AMS-CIM systems supported only low-precision weights, such as binary and ternary weights, recent state-of-the-art (SOTA) works have explored higher precision weights, such as 4-bit or 8-bit, to enhance DNN classification accuracy. SOTA AMS-CIM systems with multi-bit weights have often adopted the architecture that stores negative and positive weights in separate planes, in separate columns, or separately in tied multiple cells. This is commonly referred to as a sign-and-magnitude (SNM) format. In this architecture, the corresponding analog MAC results for negative and positive weights are computed individually and combined in the analog or digital domain. It should be noted that this architecture requires two memory cells to express one weight, which leads to degrading the area efficiency.

Some AMS-CIM architectures have employed the two's complement (2SC) format, and achieved the enhanced area efficiency with only one cell per bit. Also, it is known that using the 2SC format substantially reduces energy overhead in analog-to-digital converters (ADCs), which convert analog MAC results to digital values to use for subsequent deep neural network (DNN) layer processing. This further enhances the overall energy efficiency since ADCs in AMS-CIM systems consume considerable energy.

However, applying high-precision weights on AMS-CIM systems using the 2SC format worsens the aforementioned challenges of these systems. The challenges stem from the significant presence of on-cells, which are memory cells that conduct on-current when activated. The AMS-CIM systems experience outcome deviations due to process variations. According to research, these deviations are closely associated with the number of activated on-cells (here, assuming substantial difference in current between on-cell and off-cell). This assumption holds true for various memory types, including SRAM, RRAM, and Flash. The variation of the on-cell current is much wider than that of the off-cell current. Therefore, the increasing number of on-cells may have the greater impact on the final accuracy.

Since DNN weights traditionally follow Gaussian distribution centered around zero, SNM-based and 2SC-based CIMs show significant difference in distributions of ‘0’s and ‘1’s per bit. Due to this distribution characteristic, the number of on-cells is smaller in the SNM format since ‘0’ is statistically dominant in higher-order bits. In contrast, since the 2SC-based architecture maintains the nearly balanced distribution of ‘0’s and ‘1’s across all logical-order bits, the number of on-cells increases in higher-order bits, which is the same although true-cell or anti-cell coding techniques are used. This ‘0’-‘1’ balance results in more substantial computational errors in higher-order bits of the analog MAC results, which leads to further degrading DNN accuracy compared to the SNM-based architecture. Also, as the number of on-cells increases, the cell current during DNN operation increases, which leads to reducing energy efficiency to the certain extent.

### SUMMARY

To address the aforementioned challenges, the present disclosure proposes a software-hardware co-design technique, Skew-CIM. Skew-CIM introduces a weight skewing (WESK) technique at the software level, intentionally breaking the balance between the number of ‘0’s and the number of ‘1’s. The experimental results show that the potential degradation in DNN accuracy caused by WESK may be almost completely compensated for through retraining, and the degradation in the accuracy is less than 0.4%. The present disclosure also proposes an online processing technique at the hardware level to address an offset issue in bitwise analog MAC results caused by WESK. WESK significantly reduces the number of on-cells for bits nearer to the most significant bit (MSB), which leads to alleviating computational errors caused by process variations and to enhancing energy efficiency due to a decrease in computing cell current.

The present disclosure demonstrates that the Skew-CIM technique effectively addresses the issues found in 2SC-based CIM systems by employing 8T-SRAM-based AMS-CIM as an example. However, it should be noted that the Skew-CIM technique is more generally applicable to various AMS-CIM systems that meet the following conditions. First, the AMS-CIM system needs to store and process multi-bit (more than 3-bit) weights using the 2SC format. Second, the AMS-CIM system needs to be based on a memory in which on-cell current is sufficiently larger than off-cell current and process variations of on-cells are more impactful to the accuracy drop than off-cells. Third, the AMS-CIM system needs to perform bitwise analog MAC and then merge the same in the analog or digital domain. In this case, analog MAC errors significantly occur in higher-order bits. The above conditions may be sufficiently satisfied by slightly modifying the existing SOTA AMS-CIM researches.

The main contributions of the present disclosure are summarized as follows. First, advantages and disadvantages of 2SC-based CIM compared to their SNM-based CIM are analyzed, and motivation of the present disclosure is presented. Second, Skew-CIM is proposed, which is a novel software-hardware co-design technique to address inherent issues of 2SC-based CIM. Third, an 8T-SRAM CIM system is implemented based on the proposed Skew-CIM technique. Through extensive validation, it is proved that the Skew-CIM effectively mitigates challenges inherent in the 2SC-based CIM systems.

Accordingly, the present disclosure provides a method and a device for bit-level sparsity-based analog-mixed-signal (AMS) in-memory matrix-vector multiplication with robust error characteristics, high energy efficiency, and high computational speed.

The present disclosure provides an operating method of a computing device for performing an analog-mixed-signal-based in-memory-matrix multiplication operation using an input vector having bit-level sparsity, and the operating method of the computing device may include detecting the number of logical value ‘1’s within an input vector; reconstructing the input vector into a plurality of partial input portions each including a preset number of logical value ‘1’s, based on the detected number; activating wordlines equal to or less than the preset number in a memory array, and applying the partial input portions to the activated wordlines; and performing a matrix-vector multiplication operation based on a current response of the memory array.

The present disclosure provides a computing device for performing an analog-mixed-signal-based in-memory-matrix multiplication operation using an input vector having bit-level sparsity, and the computing device may include a memory; and a processor configured to connect to the memory and to execute at least one instruction stored in the memory, and the processor may be configured to detect the number of logical value ‘1’s within an input vector, to reconstruct the input vector into a plurality of partial input portions each including a preset number of logical value ‘1’s, based on the detected number, to activate wordlines equal to or less than the preset number in a memory array, and apply the partial input portions to the activated wordlines, and to perform a matrix-vector multiplication operation based on a current response of the memory array.

The present disclosure provides a non-transitory computer-readable recording medium storing a computer program to execute a method of performing an analog-mixed-signal-based in-memory-matrix multiplication operation using an input vector having bit-level sparsity on a computing device, and the method may include detecting the number of logical value ‘1’s within an input vector; reconstructing the input vector into a plurality of partial input portions each including a preset number of logical value ‘1’s, based on the detected number; activating wordlines equal to or less than the preset number in a memory array, and applying the partial input portions to the activated wordlines; and performing a matrix-vector multiplication operation based on a current response of the memory array.

The present disclosure may achieve the following effects.

First, it is possible to ensure high computational reliability. Through technology of limiting the number of simultaneously activated WLs (SAWL), it is possible to minimize the probability of computational errors due to process, voltage, temperature (PVT) variations. By ensuring the stable input dynamic range, it is possible to reduce interference between analog signals and to improve computational reliability.

Second, it is possible to enhance computational latency and processing bandwidth. By proposing a technique (BitSift-GEMV) capable of simultaneously processing data of the maximum length including the fixed number of ‘1’s using bit-level sparsity of input data, it is possible to reduce the latency caused by frequent data segmentation and to significantly improve the processing bandwidth. Through this, it is possible to provide excellent performance in large-scale data processing and real-time application.

Third, it is possible to enhance energy efficiency. By minimizing redundant operation and data transmission in an input processing and computational process, it is possible to significantly reduce energy consumption. In particular, through efficient data processing within fixed SAWL, it is possible to implement a low power design that provides high performance with lower energy consumption.

Fourth, it is possible to alleviate analog-to-digital converter (ADC) requirements and to enhance hardware stability. It is possible to reduce the burden of high effective number of bits (ENOB) ADCs required in the conventional methods, and to enable stable operations even with a relatively simple ADC design. Through this, it is possible to reduce implementation complexity of an analog-mixed-signal-based system and to reduce hardware cost.

Fifth, it is possible to perform transformer-based model and DNN optimization. The present disclosure may efficiently process large-scale vector-matrix multiplication (general matrix vector multiplication (GEMV)) operations essential for a transformer-based model, and to effectively utilize bit-level sparsity characteristics found in most DNNs. It is possible to achieve high compatibility with the state-of-the-art technology, such as post-training quantization (PTQ), and to guarantee accurate computation results.

Sixth, it is possible to achieve scalability and applicability. The proposed SAWL_{D} controller and BitSift-GEMV controller may provide scalability that may process various input sizes and signal characteristics. This allows them to be employed in the wide field of applications, such as large-scale data processing, energy-constrained systems, and real-time computing environments.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates comparison of representative analog-mixed-signal (AMS) compute-in memory (CIM) (AMS-CIM) architectures using the same computation example;

FIG. 2 illustrates analysis of inherent analog error sources occurring in an AMS-CIM system using 8T-SRAM memory;

FIG. 3 illustrates the statistical distribution of analog-computed bitwise-MAC results;

FIG. 4 illustrates bit profiles of DNN weights at all bit positions;

FIG. 5 illustrates weight binary mapping after employing a weight skewing (WESK) technique according to the present disclosure;

FIG. 6 illustrates an algorithm of Skew-CIM software according to the present disclosure;

FIG. 7 illustrates a configuration of Skew-CIM hardware according to the present disclosure;

FIG. 8 illustrates an algorithm of Skew-MAC circuit according to the present disclosure;

FIG. 9 illustrates a method in which a Skew-CIM hardware block compensates for WESK offset according to the present disclosure;

FIG. 10 illustrates a SAWL_{D} controller according to the present disclosure;

FIG. 11 is a diagram illustrating a computing device according to the present disclosure; and

FIG. 12 is a flowchart illustrating an operating method of a computing device according to the present disclosure.

### DETAILED DESCRIPTION

The present disclosure provides a method and a device for bit-level sparsity-based analog-mixed-signal (AMS) in-memory matrix-vector multiplication with robust error characteristics, high energy efficiency, and high computational speed.

The present disclosure proposes a bit-level sparsity-based analog-mixed signal (AMS) in-memory matrix-vector multiplication (general matrix vector multiplication (GEMV)) technique and circuit that may provide high energy efficiency and computational speed while being robust against process, voltage, and temperature (PVT) variations. The present disclosure is designed to provide high performance even in large-scale data processing and energy-constrained application environments by realizing high-speed computation and low-power characteristics by effectively utilizing bit-level sparsity in an analog-mixed-signal environment. In particular, the present disclosure supports accurate partial sum computation and high bit accuracy to be suitable for post-training quantization (PTQ), and includes a structure that may maintain accuracy while significantly improving computational efficiency compared to the conventional technology. In addition, the present disclosure supports high bandwidth vector-matrix multiplication operations, provides high throughput in various application environments, and ensures stable and reliable results by minimizing computational errors.

Hereinafter, the present disclosure is described in more detail with reference to the accompanying drawings.

1. 2SC Vs. SNM in AMS-CIM System
1) 2SC Vs. SNM in Terms of Area and Energy Efficiency

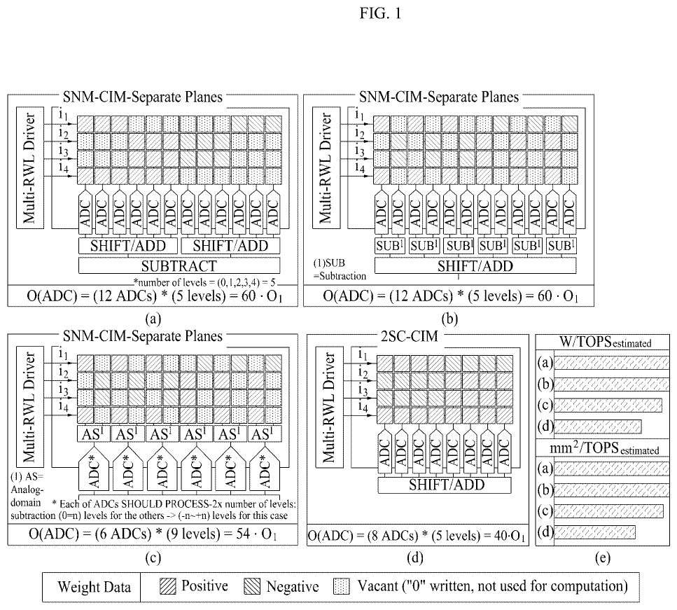

In this section, the reason why the 2SC-based AMS-CIM system has the excellent area and energy efficiency compared to the SNM-based architecture is analyzed. While research on novel cell configurations and architectures for AMS-CIM systems has been rapidly increasing, it is virtually impossible to consider them all. Therefore, the present disclosure focuses on analyzing only a few representative architectures shown in FIG. 1. The architectures enable comparison and estimation of overhead of memory cell array and analog-to-digital converters (ADCs), which account for a large proportion of energy consumption and area occupancy in the AMS-CIM system, in SNM-based and 2SC-based structures.

FIG. 1 illustrates comparison of representative AMS-CIM architectures using the same computation example (2×(2×2) 4-bit weight filters, 4× bit-serial inputs). In FIG. 1, (a) relates to SNM-CIMs using separate positive/negative planes, (b) relates to SNM-CIMs extending ternary mapping of weights to multi-bit weights, (c) relates to SNM-CIMs with bound-two cell structure that includes a signed operation within a cell, and (d) relates to 2SC-CIMs. (e) represents summarized energy/area efficiency of architectures shown in (a) to (d).

Initially, the cell-area overhead for each design is analyzed. (a), (b), and (c) of FIG. 1 show three feasible implementation examples of the SNM-based CIM structure, which conventionally require 2×(k−1) cells for representation of one weight with k-bit integer precision. Some studies have proposed a customized memory cell structure to reduce the number of cells per weight. However, this structure is excluded from this analysis due to its significantly large cell area. On the contrary, (d) of FIG. 1 shows an implementation example of the 2SC-based CIM structure, and utilizes only k cells for a k-bit weight, thereby providing more excellent area efficiency compared to the SNM-based structure.

To compare the ADC overhead between SNM-based and 2SC-based systems, an approximate formula for the ADC overhead (O(ADC)) for the AMS-CIM system was derived. Since, aside from a core memory area, ADCs are the predominant consumers of chip area and energy in most AMS-CIM designs, comparing overhead only based on the ADCs allows for more insightful comparison of TOPS/mm² and TOPS/W rather than considering only a memory array.

For comprehensive analysis, it is assumed that partial sum values are not truncated or lost during an analog-to-digital conversion process. This assumption enables analysis results to be applied to various designs including partial sum quantization/truncation. The ADC overhead (O(ADC)) typically increases in the exponential form with the effective number of bits (ENOB) of the ADC. Therefore, the overall ADC overhead of the AMS-CIM system may be represented as shown in [Equation 1] below.

$$O ( ADC ) \approx ( Number of ADCs ) \times ( Number of levels ) \approx ( Number of ADCs ) \times {2}^{ENOB ( ADC )} \qquad [ Equation 1 ]$$

FIG. 1 shows the ADC overhead (O(ADC)) of each structure when it is assumed that there are only four memory rows. The number of memory columns is determined by the architecture. It is assumed that this analysis uses 4-bit integer weights. In this case, while the SNM-based architectures presented in (a) and (b) of FIG. 1 require 12 ADCs, the 2SC-based system in (d) of FIG. 1 only requires 8 ADCs. The SNM-CIM structure shown in (c) of FIG. 1 uses the fewest number of, six, ADCs, however, these ADCs need to handle nearly twice the number of levels compared to other structures, which results in greater overhead. Therefore, the 2SC-CIM presented in (d) of FIG. 1 has lower ADC overhead (O(ADC)) than that of all SNM-based structures. That is, the 2SC-based AMS-CIM system exhibits superior area and energy efficiency compared to the SNM-based structure due to its enhanced cell efficiency and reduced ADC overhead. The W/TOPS and mm²/TOPS results shown in (e) of FIG. 1 confirm the above analysis.

### 2) Analysis of Analogy Domain Errors.

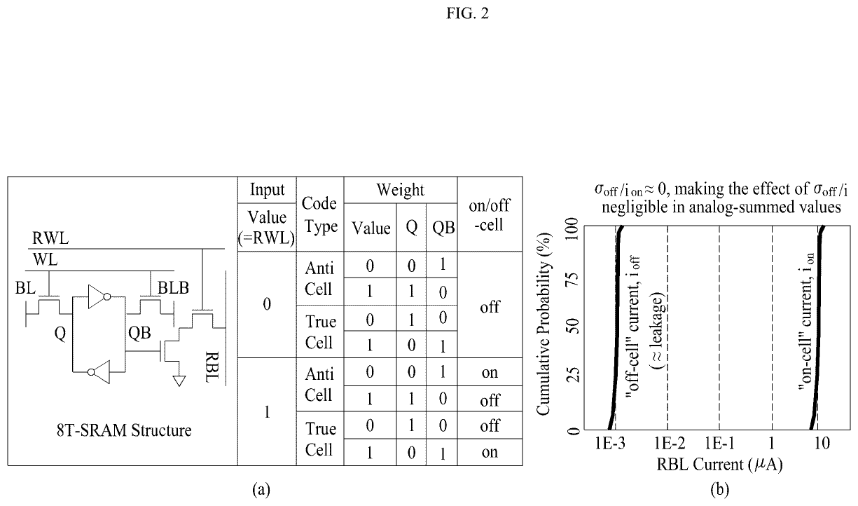

FIG. 2 illustrates analysis of inherent analog error sources occurring in an AMS-CIM system using 8T-SRAM memory. In FIG. 2, (a) illustrates true-cell and anti-cell coding of the 8T-SRAM memory, and (b) illustrates cumulative distributions of RBL current of on-cells and off-cells when activated.

Herein, the inherent analog error sources occurring in the AMS-CIM system are analyzed, and an error model for analog MAC operations are constructed. For analysis, the 8T-SRAM memory as shown in (a) of FIG. 2 is used. This is because SRAM may be more easily customized to implement analog-in-memory operation than other memories, and a disturbance issue occurring when a plurality of RWLs are simultaneously activated in 6T-SRAM does not occur in the 8T structure. However, the Skew-CIM technique does not rely on the unique characteristics of the 8T-SRAM, and is adaptable to most binary memories (e.g., SRAM, RRAM, Flash) that display the substantial current difference between on-cells and off-cells.

In the 8T-SRAM, two coding scenarios, that is, true-cell coding and anti-cell coding, may be used. For the true-cell coding, ‘0’/‘1’ are associated with V_{Q}=VDD/0 and V_{QB}=0/VDD, respectively. In contrast, the anti-cell coding uses mapping reverse to the true-cell coding. Therefore, ‘1’ is an on-cell in the true-cell coding and ‘0’ is an on-cell in the anti-cell coding. These relationships are summarized in the table shown in (a) of FIG. 2. When performing reading in the 8T-SRAM, RWL is activated and WL is disabled. Herein, this RWL activation state is defined as “cell activation.”

(b) of FIG. 2 shows the result of simulating cumulative distributions of RBL current of on-cells and off-cells. The ratio of on-cell current and off-cell current is about 10⁴ to 10⁵. In the AMS-CIM system, analog MAC is performed by simultaneously activating a plurality of RWLs. Here, a computational value is computed using the current summation of activated cells. Since the on-cell current is larger than the off-cell current, the off-cell current variation is negligible in the overall MAC errors. Therefore, the MAC errors are determined based on the number of activated on-cells, which is discussed in more detailed below.

### (1) Error Depending on the Number of On-Cells

This section demonstrates that analog MAC errors increase according to the number of activated on-cells. To conduct a meticulous error analysis, only bitwise MAC operations are considered and the influence of various standard deviations of the cell read-current on the analog error is analyzed. This analysis assumes the following AMS-CIM conditions: \textcircled{1} bitwise MAC operations for each bit position of weights/inputs are executed on a per-column/per-cycle basis in the analog domain; \textcircled{2} analog partial sums are digitized without loss (no truncation); and \textcircled{3} multi-bit MAC is combined in a shift-add manner in the digital domain.

The analytical framework of the present disclosure is adaptable, and may be expanded to a scenario of performing shift-add processing of multiple bitwise-MAC operations in the analog domain or a scenario of performing all the multi-bit MAC operations in the analog domain and then performing quantization through analog-to-digital conversion. These scenarios represent other prevalent approaches widely used in the AMS-CIM system.

In the assumed scenario, the analog operation in each column involves bitwise-MAC operations for pairs of binary inputs and weights (K×Aᵢs and K×Wᵢs). The result of analog, bitwise-MAC operations is the same as the number of on-cells with activated RWLs. This is called PopCount (PC) operation. PC of the column is represented using an analog value as shown in [Equation 2] below.

$${\sum }_{i = 0}^{K} \{ {A}_{i} \times ( {W}_{i} + δ {W}_{i} ( x ) ) \} \qquad [ Equation 2 ]$$

Here, Aᵢ denotes an activation input, Wᵢ denotes ideal on-cell current (on-cell: when V_{QB}=VDD in (a) of FIG. 2)) or off-cell current (off-cell: when V_{QB}=0 in (a) of FIG. 2), and δWᵢ(x) denotes the random variation for the cell read-current, which differs depending on on-cell and off-cell conditions (i.e., x=on-cell or off-cell). (b) of FIG. 2 shows that Wᵢ+δWᵢ corresponding to an off-cell is nearly negligible compared to an on-cell. Therefore, the PC highly correlates to the number of activated (Aᵢ=1) on-cells (Wᵢ=1).

The early discussion indicates that the analog MAC errors may be alleviated by reducing the number of activated rows

$$( NActR = {\sum }_{i = 0}^{K} {A}_{i} )$$

or by reducing the number of on-cells within the memory. A regularization technique was proposed to reduce NActR in binary neural networks in which an activation value is binarized to ‘0’ or ‘1’. However, this technique may not be applied to a multi-bit activation situation. Regularizing randomly varying NActR in the AMS-CIM system with multi-bit activations is very challenging. On the other hand, the WESK technique of the present disclosure may reduce the number of on-cells, which may be easily implemented in weights stationarily stored in the memory, as described below.

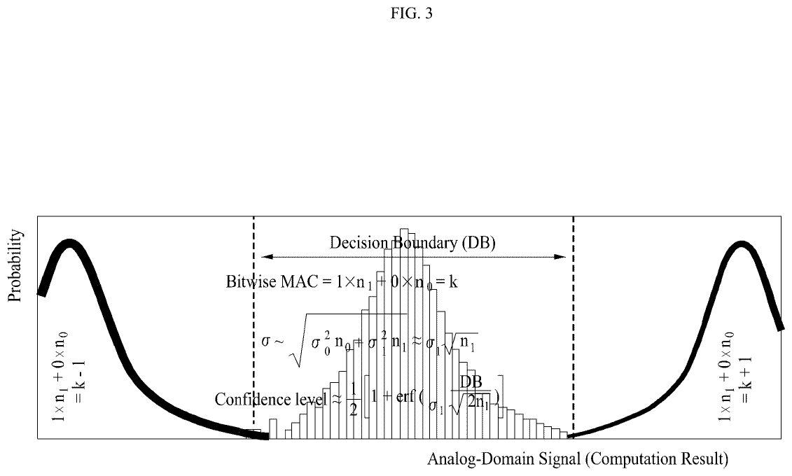

FIG. 3 illustrates the statistical distribution of analog-computed bitwise-MAC results.

The relationship between the number of on-cells and off-cells involved in computation and the probability (confidence) of correct computation is derived based on the aforementioned bitwise-MAC scenario. The following derivation process is visualized in FIG. 3. When the number of on-cells and the number of off-cells involved in computation are n₁ and n₀, respectively (n₁+n₀=“K” (“K” in [Equation 2] above)), and the standard deviation of on-cell current and the standard deviation of off-cell current are σ₁ and σ₀, respectively, the standard deviation of analog bitwise MAC may be determined and approximated as shown in [Equation 3] below.

$$σ \approx \sqrt{{σ}_{0}^{2} {n}_{0} + {σ}_{1}^{2} {n}_{1}} \approx {σ}_{1} \sqrt{{n}_{1}} \qquad [ Equation 3 ]$$

With σ₁»σ₀ as shown in (b) of FIG. 2, the confidence level of analog bitwise-MAC computation may be derived as shown in [Equation 4] below.

$$Confidence level \approx \frac{1}{2} [ 1 + erf ( \frac{DB}{{σ}_{1} \sqrt{2 {n}_{1}}} ) ] \qquad [ Equation 4 ]$$

Here, DB represents a decision boundary used for digitization in ADC. This analysis implies that, as the number of on-cells increases, the standard deviation increases and the confidence level for computation decreases. This suggests there is a need to design the reduction of on-cells' involvement in AMS computation.

### (2) Error Depending on Bit Position

In the analog-signal domain, the aforementioned errors occur before digitization. If the errors in the analog domain propagate to their corresponding digital values, these propagated digital values are multiplied by a factor of 2ⁿ⁻¹. Here, n denotes a bit position of a weight (n=1 for least significant bit (LSB)).

As a result, errors in higher-order bits (e.g., MSBs) become more critical for system accuracy and need to be mitigated with higher priority. The Skew-CIM technique is proposed based on this reasoning and aims to reduce the number of on-cells, particularly, in the MSB domain. By minimizing errors in MSBs, the overall accuracy and reliability of the system may be significantly enhanced.

### 3) Motivation of the Proposed Skew-CIM Technique

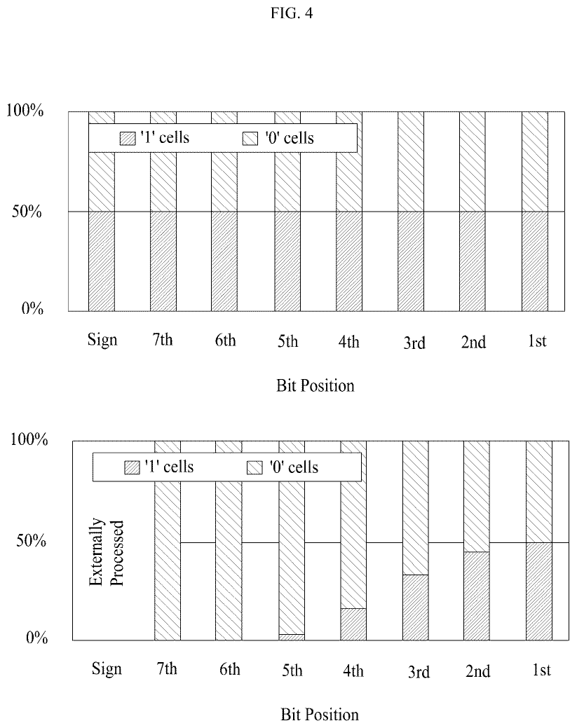

FIG. 4 illustrates bit profiles of DNN weights at all bit positions in both 2SC (top) and SNM (bottom). The 2SC-CIM may be implemented in more compact hardware than the SNM-CIM, but may be more susceptible to errors due to the balanced distribution of ‘1’s and ‘0’s.

FIG. 4 shows the distribution of weight-bit ‘0’ and ‘1’ in a DNN having 8-bit weights in both 2SC and SNM formats. Since the SNM-CIM does not store a sign bit in its memory cell, the sign bit of the SNM case is excluded. The distribution of the SNM exhibits considerable skew toward ‘0’, while the 2SC case demonstrates the nearly balanced distribution of ‘0’ and ‘1’. This is because most quantized weight values of DNN layers are centered symmetrically around zero. Also, in the SNM-CIM architectures shown in (a) and (b) of FIG. 1, unused memory cells store ‘0’, making ‘0’ more dominant in the SNM-CIM. As a result of analyzing previous works, this trend is consistently observed across most DNNs, irrespective of their weight and activation precision.

Considering these distribution characteristics, despite the significant power and area efficiency advantages of the 2SC-CIM over the SNM-CIM, there is a risk that the impact of parametric process variation may be potentially amplified due to the balanced distribution of ‘0’ and ‘1’, particularly in higher-order bits. Therefore, this heightened sensitivity in the 2SC-CIM motivates the Skew-CIM technique proposed in the following section.

### 2. Skew-CIM: Technique for Reducing the Number of On-Cells in 2SC-Based CIM

Herein, a core element of the Skew-CIM technique, WESK, is described in detail along with a software optimization procedure for the WESK and a hardware processing technique for compensating for offset occurring due to the WESK. The proposed WESK plays a crucial role in recovering DNN accuracy compromised by process variations, and also significantly enhances the energy efficiency of AMS-CIM-based DNN acceleration.

### 1) WESK Technique

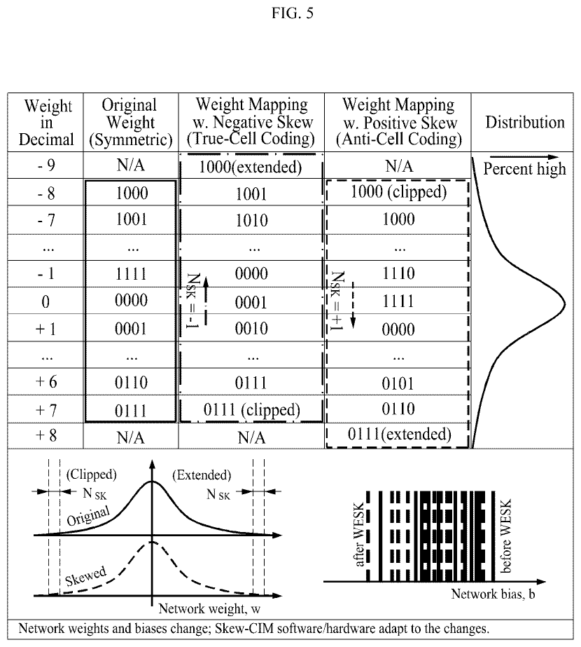

FIG. 5 illustrates weigh binary mapping after applying WESK according to the present disclosure. In FIG. 5, as an example of a 4-bit weight system, a unit WESK offset is applied in positive or negative direction (N_{SK}=+/−1). By applying the WESK, weight mapping is skewed to reduce the number of ‘0’s or ‘1’s. As a result, the range of weight representation is clipped and extended. Although integer-based bit precision varies, the process of applying an integer level shift (extending and clipping) per unit WESK remains consistent. However, in the case of using higher bit precision, the change in the dynamic range of weights becomes relatively smaller, but the impact of WESK on adjusting weight mapping becomes more potent. Therefore, the method proposed herein may be a more effective solution for addressing analog variability. Skew-CIM software reflects changed DNN parameters (see bottom image) by performing retraining in a per-filter optimization process, and Skew-CIM hardware compensates for offset occurring in a computation process due to the WESK.

The present disclosure proposes the WESK technique to address the issue of on-cells in higher-order bits (MSBs) that significantly impact computational errors. This phenomenon is because many small positive weights contain many ‘0’s and many small negative weights contain a plurality of ‘1’s. As shown in FIG. 5, this issue may be mitigated by introducing skew in weights.

When applying the WESK in the positive direction, the number of ‘0’s significantly decreases in small positive weights. Conversely, when applying the WESK in the negative direction, the number of ‘1’s decreases in small negative weights. Due to this, an anti-cell-coded memory device may acquire benefits from positive WESK (N_{SK}>0) application and a true-cell-coded memory device may acquire benefits from negative WESK (N_{SK}<0) application. The experimental results show that positive skewing is more advantageous in terms of baseline DNN classification accuracy when analog errors are absent. Therefore, this research selects an anti-cell coding scenario as hardware baseline due to its better performance in this context.

A combination of software and hardware techniques is required to effectively apply the Skew-CIM to a DNN model together with the WESK and to mitigate its impact while preserving accuracy. Initially, a processing technique is required at the software level to generate a network with reduced on-cell weights. This process is referred to as “Skew-Net” generation. Through this, the skewed DNN weights (Wᵢ−N_{SK}) are stored across a designated set of columns in the memory.

Subsequently, specific circuit blocks are required at the hardware level to recover the computation offset caused by the WESK during runtime. The circuit blocks enable online compensation for the effect of the WESK. A Skew-Net generation process and a hardware compensation technique are further described below.

### 2) Skew-CIM Software Design

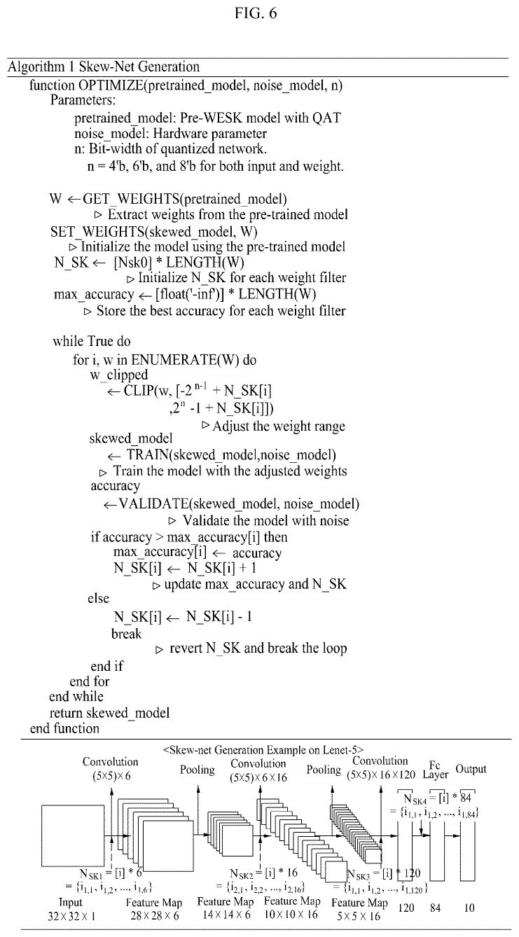

FIG. 6 illustrates an algorithm of Skew-CIM software according to the present disclosure.

After formulating the proposed WESK technique, the present disclosure constructs a software framework that optimizes various DNN models by applying filter-wise WESK and generates a fine-tuned network model (Skew-Net). The Skew-Net is generated through the following procedure: \textcircled{1} load or generate a pretrained quantization model to which any skew is not applied by utilizing quantization-aware training; \textcircled{2} skew the weight range per filter using various N_{SK} values; \textcircled{3} retrain network parameters for the skewed weight range for fine-tuning (weights and biases are learned; weight distribution remains almost the same except for clipped or extended outlier values, while bias values change considerably); \textcircled{4} iterate \textcircled{2} and \textcircled{3} to improve accuracy while performing validation using a noise model; and \textcircled{5} write on memory with skewed representation. This network generation algorithm is automated for optimization, and is presented in a code snippet with an example model in Algorithm 1 of FIG. 6. Meanwhile, at the hardware level, some operations for recovering the offset caused by the WESK are required, which is described below.

### 3) Addressing the Impact of WESK Offset (N_{SK}) in MAC Computation

In the case of utilizing DNN weights with skewed representation in the memory, AMS-MAC operations are performed, which is referred to as Skew-MAC. The Skew-MAC result for K rows (inputs) is given by [Equation 5] below.

$${\sum }_{i = 1}^{K} {A}_{i} \times ( {W}_{i} - {N}_{SK} ) \qquad [ Equation 5 ]$$

Here, Aᵢ and Wᵢ denote multi-bit activation and multi-bit weight corresponding to an i^{th} memory row, respectively, and N_{SK} denotes a value that expresses the skew degree. To acquire a desired output value

$$( = {\sum }_{i = 1}^{k} {A}_{i} \times {W}_{i} ) , a term ( {\sum }_{i = 1}^{k} ( {N}_{SK} \times {A}_{i} ) ) ,$$

called the WEST offset, needs to be added to the Skew-MAC result. Here, N_{SK} is a fixed parameter that is determined at the software level. However,

$${\sum }_{i = 1}^{k} {A}_{i}$$

needs to be computed online during runtime. The following section presents an example of implementing such online processing at the hardware level.

### 3. Hardware Implementation Example Using the Proposed Skew-CIM

Herein, an example of hardware designed based on the proposed Skew-CIM technique is described. Herein, Skew-CIM hardware is implemented using 28-nm FD-SOI process for experiments. Through this hardware, the effectiveness and potential tradeoff the Skew-CIM design technique may be thoroughly evaluated.

The present disclosure conducted extensive Monte-Carlo simulation on the Skew-CIM hardware to analyze the impact of process variations. 10,000 bins of simulation for each case across various combinations of NActR and cell data were conducted. Both inter-die variation and intra-die variation were considered. Through this simulation, the effect of variations in on-cells and off-cells on analog computations was able to be parameterized, making it possible to validate the efficacy of the Skew-CIM technique of the present disclosure.

### 1) Baseline Hardware Architecture.

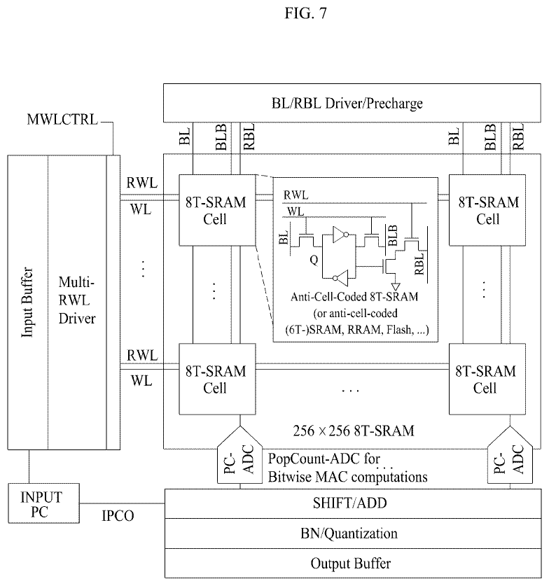

FIG. 7 illustrates a configuration of Skew-CIM hardware according to the present disclosure. This design may be applied to other current-read-based memory devices.

The Skew-CIM hardware of the present disclosure is illustrated in FIG. 7, which is designed to perform scaled integer-based MAC operations (through AMS-MAC computation, batch normalization (BN), and quantization) and to seamlessly integrate the proposed WESK technique. This system stores and processes data using the 2SC format presented in (d) of FIG. 1. Integrating a BN/quantization block in the system is not essential, but noticeably enhances the accuracy of a neural network model, particularly, in an environment with quantized activation values and weights. Therefore, the proposed architecture includes a well-calibrated BN/quantization block in accordance with principles outlined in relevant research. Thanks to the quantization technique combined with the aforementioned BN technique, the BN/quantization blocks were able to be directly implemented in on-chip, making it possible to further enhance the energy efficiency and accuracy of the baseline system.

Despite 6T-SRAM implementation being more advantageous in terms of area efficiency, the present disclosure selected 8T-SRAM to ensure higher reliability. This is also to avoid instability inherent in the 6T-SRAM described above in 2) of section 1. Also, as discussed in 1) of section 2, the anti-cell coding scenario was adopted over the true-cell coding scenario to achieve better DNN baseline accuracy with positive WESK application.

### 2) Circuit Block for DNN Computations: For Precise Simulation of the Proposed Technique

The system's core for DNN computations is a multi-bit MAC structure including per-column, bitwise-MAC operations. The key circuit blocks for performing these computations include a multi-RWL driver with an input buffer, a PopCount (PC)-ADC per column, a SHIFT/ADD block, a BN/quantization block, and an output buffer. K-bit weights are stored across k columns in logical-bit order, and independent filters are stored across other k-column groups in a memory array. In an input aspect, Skew-CIM hardware feeds multi-bit activation onto the array using a bit-serial scheme, which is one of representative schemes that bias multi-bit activation in the AMS-CIM system.

In this structure, the multi-RWL driver with the input buffer applies a plurality of independent inputs representing pixels of an activation map across various RWLs, which is performed for operation cycles corresponding to the bit-width of input data. The current of each bit-line represents the dot-product between input rows and a weight column, and is subsequently converted to a digital value by the PC-ADC. This ADC performs a function of counting the number of activated “pops (on-cells)” in the corresponding column, so called pop-count ADC (PC-ADC).

To ensure the robust evaluation of the proposed technique, the PC-ADC of the present disclosure provides high-precision and lossless digitization without truncation or bit-width reduction. It may be desirable to design an ADC that is shared between columns, and to apply truncation in order to enhance energy efficiency. However, the study herein aims to precisely evaluate the proposed technique, so employed a method of preserving data quality and lossless characteristics throughout all computation stages.

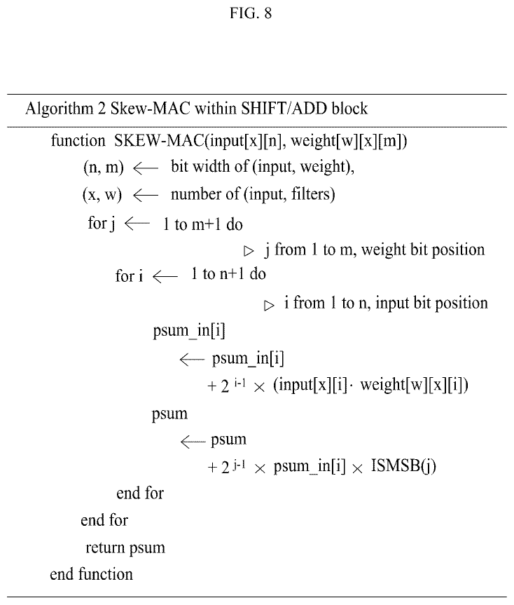

FIG. 8 illustrates an algorithm of Skew-MAC circuit according to the present disclosure.

The output of the PC-ADC is delivered to the SHIFT/ADD block that processes signed operations that employ the 2SC format. Since the proposed block only requires straightforward shift-and-add operations of bitwise-MAC results and a single sign inversion operation per MAC operation, complex sign extension is not required. As a result, the Skew-MAC circuit is as simple as that of unsigned integer multiplication. This operating method is presented in detail in the form of a loop-based algorithm in Algorithm 2 of FIG. 8.

Owing to lossless digitization processing, Skew-CIM hardware may embed fully functional and flexible batch normalization and quantization functions within the BN/quantization block. To further increase energy efficiency, a method of applying an ADC/digital-to-analog converter (DAC)-based design for BN may be considered. Even this case, the Skew-CIM technique proposed in the present disclosure is still applicable.

### 3) Circuit Block for Online Processing to Compensate for WESK Offset

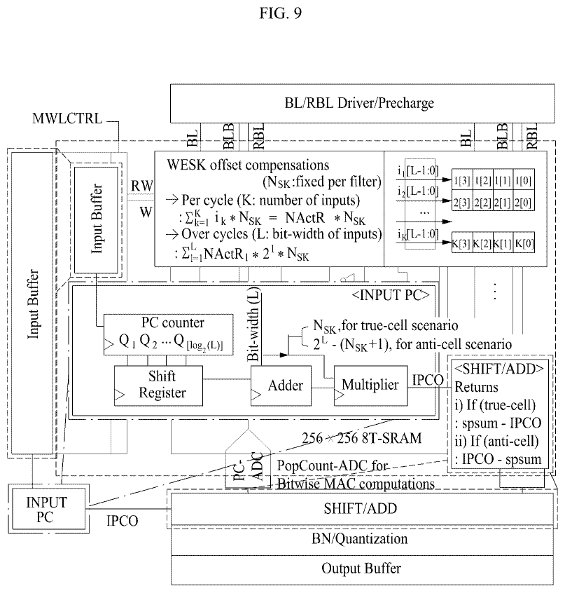

FIG. 9 illustrates a method in which a Skew-CIM hardware block compensates for WESK offset according to the present disclosure. Here, a “spsum” calculation process within the SHIFT/ADD block corresponds to Algorithm 2 of FIG. 8.

After the Skew-MAC result (spsum) is processed in the SHIFT/ADD block, a compensation operation is performed in the form of (spsum−IPCO) or (IPCO−spsum) upon its cell-coding scenario to compensate for the WESK offset. This compensation process is supported by the INPUT-PC block that returns an IPCO value. The structure of the INPUT-PC block is shown in FIG. 9 and requires very small overhead. The operation of the INPUT-PC block is based on the following analysis. In Skew-CIM hardware using a serial coding scenario, the summation of input values

$$( {\sum }_{i = 1}^{k} {A}_{i} )$$

is given by [Equation 6] below.

$${\sum }_{i = 1}^{K} {A}_{i} = {\sum }_{l = 1}^{L} N Act {R}_{l} \times {2}^{l} \qquad [ Equation 6 ]$$

Here, L denotes activation precision, and 1 denotes a logical bit position of each serial input. Using this relationship, the following IPCO value is computed in the INPUT-PC block as shown in [Equation 7] below, and this value is delivered to the SHIFT/ADD block in Skew-MAC hardware to compensate for the WESK offset.

$$IPCO = {\sum }_{i = 1}^{K} {N}_{SK} \cdot {A}_{i} = {N}_{SK} \times {\sum }_{i = 1}^{K} {A}_{i} = \{ \begin{matrix}{N}_{SK} \times {\sum }_{l = 1}^{L} N Act {R}_{l} \times {2}^{l} & ( for true - cell ) \\ ( {2}^{L} - ( {N}_{SK} + 1 ) ) \times {\sum }_{l = 1}^{L} N Act {R}_{l} \times {2}^{l} & ( for anti - cell )\end{matrix} , \qquad [ Equation 7 ]$$

Here, L and N_{SK} are fixed values in the entire DNN, and “NActR” is derived from the input through an online processing process. The difference depending on cell-type changes depending on at which value (‘0’ or ‘1’) the pop-count result aims. Hereinafter, a detailed derivation procedure of the WESK compensation process is described for each of positive WESK and negative WESK.

For negative WESK, the WESK offset using spsum and IPCO may be compensated as shown in [Equation 8] below.

$$MAC = ( \begin{matrix}{PC}_{1 , 1} + \\ {PC}_{1 , 1} \times 2 + \\ …\end{matrix} ) + ( \begin{matrix}{PC}_{2 , 1} + \\ {PC}_{2 , 1} \times 2 + \\ …\end{matrix} ) \times 2 + … + … - ( \begin{matrix}{IPC}_{1} + \\ {IPC}_{2} \times 2 + \\ …\end{matrix} ) \times {N}_{SK} = spsum - {\sum }_{l = 1}^{L} N Act {R}_{l} \times {2}^{l} = spsum - IPCO \qquad [ Equation 8 ]$$

Here, x denotes a bit position of input, y denotes an index for independent filters for per-column popcount PCx,y, and i denotes a bit position of input for input popcount IPCᵢ. Meanwhile, for positive WESK, since the popcount relates to a method of counting the number of ‘0’s among activated rows, a computation method and a compensation method differ from the case for negative WESK.

$$MAC = ( \begin{matrix}{IPC}_{1} - {PC}_{1 , 1} + \\ ( {IPC}_{2} - {PC}_{1 , 2} ) \times \\ 2 + …\end{matrix} ) + ( \begin{matrix}{IPC}_{1} - {PC}_{2 , 1} + \\ ( {IPC}_{2} - {PC}_{2 , 2} ) \times \\ 2 + …\end{matrix} ) \times 2 + … + … - ( \begin{matrix}{IPC}_{1} + \\ {IPC}_{2} \times 2 + \\ …\end{matrix} ) \times {N}_{SK} = ( \begin{matrix}( {IPC}_{1} + {IPC}_{1} \times 2 + … + \\ {IPC}_{1} \times {2}^{n - 1} ) + ( {IPC}_{2} + \\ {IPC}_{2} \times 2 + … + {IPC}_{2} \times \\ {2}^{n - 1} ) \times 2 )\end{matrix} ) - spsum - ( \begin{matrix}{IPC}_{1} + \\ {IPC}_{2} \times \\ 2 + …\end{matrix} ) \times {N}_{SK} = ( {2}^{n} - ( {N}_{SK} + 1 ) ) \times {\sum }_{l = 1}^{L} N Act {R}_{l} \times {2}^{l} - spsum = IPCO - spsum \qquad [ Equation 9 ]$$

In summary, the core configuration of the present disclosure is as follows:

(1) the Operating Principle of Analog-Mixed-Signal-Based in-Memory Operator

Unlike digital devices, the analog-mixed-signal-based in-memory operator may process large-scale input in parallel by simultaneously activating a plurality of wordlines (WLs). However, as the amount of simultaneous throughput increases, the probability of computational errors due to interference between analog signals and PVT variations increases.

### (2) Ensuring Operational Reliability by Limiting the Number of Simultaneously Activated Wordlines (SAWL)

The present disclosure includes a technique for enhancing the reliability of analog computation by limiting the number of SAWL. Through this, while this technique may ensure high operational reliability, high latency and low processing bandwidth issues may arise due to excessive segmentation during an input processing process based on a DNN and transformer-based model.

### (3) Dynamic Processing Technique Based on Bit-Level Sparsity of Input Data

To address these issues, the present disclosure proposes an input processing technique (BitSift-GEMV) that may identify an area with an actual ‘1’ value from input data and may simultaneously process input of the maximum length with a fixed number of ‘1’s. Through this, the computational efficiency is maximized based on bit-level sparsity, and characteristics commonly found in most artificial neural networks and deep neural networks are effectively utilized.

### (4) Improving Performance and Stability of Analog Computing Unit

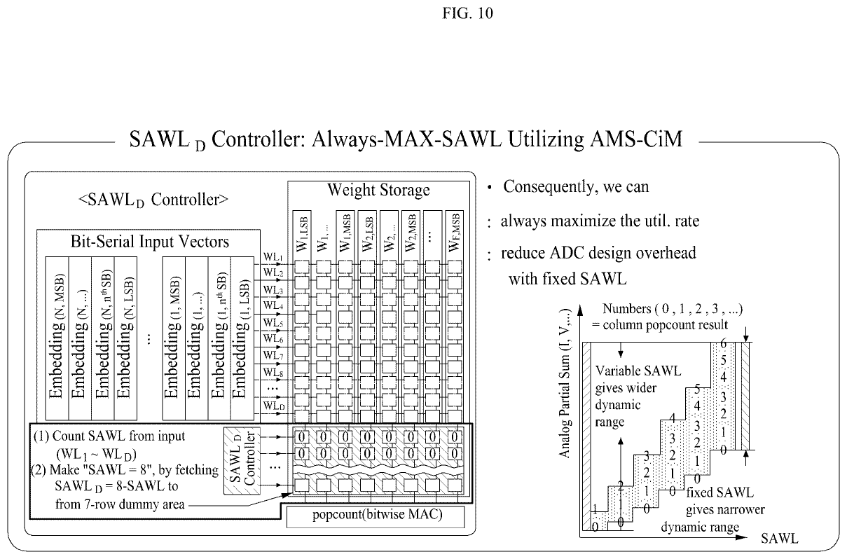

The proposed input processing technique improves the performance of the analog-mixed-signal-in-memory operator as follows: It improves ADC characteristics; ensures the stable input dynamic range and enhances the stability of analog computation stability even when the number of SAWL is limited; and provides higher stability and reliability compared to the conventional methods (see FIG. 10) and supports the high processing bandwidth with low energy consumption.

### (5) Introduction of Components

To realize this, the present disclosure designs and applies a SAWL_{D} controller and a BitSift-GEMV controller. The SAWL_{D} controller implements the optimal input representation within the limited number of WLs, and the BitSift-GEMV controller accelerates the computation using the bit-level sparsity of input.

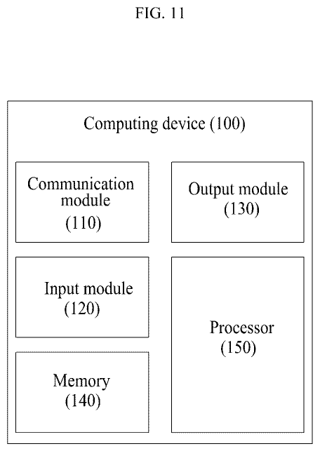

FIG. 11 is a diagram illustrating a computing device 100 according to the present disclosure.

Referring to FIG. 11, the computing device 100 is provided to perform an analog-mixed-signal based in-memory matrix-vector multiplication operation using an input vector having bit-level sparsity, that is, may be implemented to utilize the above-described Skew-CIM. Specifically, the computing device 100 may include at least one of a communication module 110, an input module 120, an output module 130, a memory 140, and a processor 150. In some example embodiments, at least one of the components of the computing device 100 may be omitted, and at least one another component may be added. In some example embodiments, at least two of the components of the computing device 100 may be implemented as a single integrated circuit. Here, the components of the computing device 100 may be configured to be integrated within a single housing, or may be configured to be distributed within a plurality of housings.

The communication module 110 may perform communication with an external device in the computing device 100. The communication module 110 may establish a communication channel between the computing device 100 and the external device and may perform communication with the external device through the communication channel. The communication module 110 may include at least one of a near field communication module and a far field communication module. The near field communication module may communicate with the external device using a near field communication method.

The input module 120 may input a signal to be used for at least one component of the computing device 100. The input module 120 may be configured to detect a signal directly input from a user, or to generate a signal by detecting an ambient change. For example, the input module 120 may include at least one of a mouse, a keypad, a microphone, and a sensing module having at least one sensor. In some example embodiments, the input module 120 may include at least one of touch circuitry configured to detect a touch and sensor circuitry configured to measure intensity of force generated by the touch.

The output module 130 may output information to the outside of the computing device 100. The output module 130 may include at least one of a display module configured to visually output information and an audio output module that may output information as an audio signal. For example, the audio output module may include at least one of a speaker and a receiver.

The memory 140 may store a variety of data used by at least one component of the computing device 100. For example, the memory 140 may include at least one of a volatile memory and a nonvolatile memory. Data may include at least one program and input data or output data related thereto. The program may be stored as software that includes at least one instruction in the memory 140, and may include at least one of an operating system (OS), middleware, and an application.

The processor 150 may control at least one component of the computing device 100 by executing the program of the memory 140. Through this, the processor 150 may perform data processing or operations. Here, the processor 150 may execute an instruction stored in the memory 140. In various example embodiments, the processor 150 may be configured to perform an analog-mixed-signal-based in-memory matrix-vector multiplication operation using an input vector having bit-level sparsity. To this end, in some example embodiments, the processor 150 may include a SAWL_{D} controller and a BitSift-GEMV controller.

The processor 150 may detect the number of logical value ‘1’s in the input vector. Based on the detected number, the processor 150 may reconstruct the input vector into a plurality of partial input portions, each including the logical value ‘1’, as a preset number. Here, if the number of logical value ‘1’s is less than a set number for at least one of partial input portions, the processor 150 may add at least one logical value ‘1’ as dummy input. The processor 150 may activate a preset number of or fewer wordlines in a memory array and may apply the partial input portions to the activated wordlines. The processor 150 may perform a matrix-vector multiplication operation based on a current response of the memory array. Specifically, the processor 150 may analogically accumulate on-cell current or off-cell current of memory cells corresponding to the activated wordlines along a bitline, and may generate an analog accumulation signal corresponding to a partial sum of the matrix-vector multiplication operation. The processor 150 may convert the analog accumulation signal to a digital partial sum value. Also, the processor 150 may generate the result of the matrix-vector multiplication operation by accumulating the digital partial sum value in the digital domain according to a bit position or a weight of the input vector.

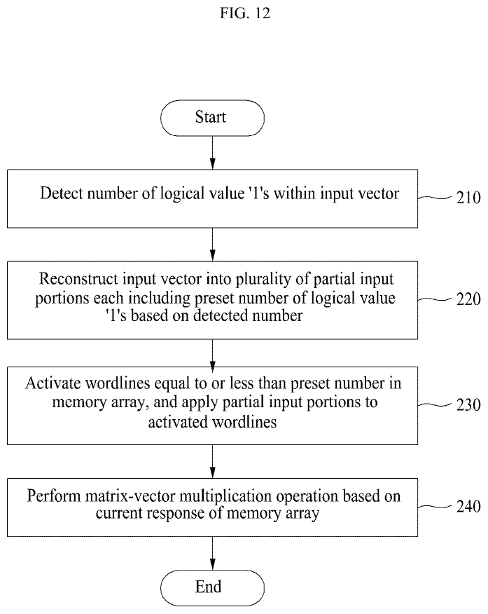

FIG. 12 is a flowchart illustrating an operating method of the computing device 100 according to the present disclosure.

Referring to FIG. 12, in operation 210, the processor 150 may detect the number of logical value ‘1’s within an input vector. In operation 220, the processor 150 may reconstruct the input vector into a plurality of partial input portions each including a preset number of logical value ‘1’s. Here, if the number of logical value ‘1’s is less than the preset number for at least one of the partial input portions, the processor 150 may add at least one logical value ‘1’ as dummy input. In some example embodiments, the memory array may include skewing-based weight mapping, and the set number for the logical value ‘1’ may be configured to compensate for the on-cell bias due to the skewing.

In operation 230, the processor 150 may activate wordlines equal to or less than the preset number in a memory array, and may apply the partial input portions to the activated wordlines. In some example embodiments, the set number for the wordlines may be determined based on a reference value for suppressing the increase in the nonlinear distribution of analog signals, the signal deviation according to process, voltage, temperature (PVT) variations, and the increase in the distribution of on-cell current. A region of the memory array to which the dummy input is applied may include dummy cells storing a weight state that does not generate a current response to not influence the result of the matrix-vector multiplication operation.

In operation 240, the processor 150 may perform a matrix-vector multiplication operation based on a current response of the memory array. Specifically, the processor 150 may generate an analog accumulation signal corresponding to a partial sum of the matrix-vector multiplication operation by accumulating the on-cell current or the off-cell current of memory cells corresponding to the activated wordlines in an analog manner. Then, the processor 15 may convert the analog accumulation signal to a digital partial sum value. Here, the processor 150 may convert the analog accumulation signal to the digital partial sum value using an ADC. Then, the processor 150 may generate the result of the matrix-vector multiplication operation by accumulating the digital partial sum value in the digital domain according to bit importance of the input vector. Here, the bit importance may include at least one of a bit position and a weight of the input vector.

Therefore, the present disclosure may achieve the following effects.

First, it is possible to ensure high computational reliability. Through technology of limiting the number of simultaneously activated WLs (SAWL), it is possible to minimize the probability of computational errors due to PVT variations. By ensuring the stable input dynamic range, it is possible to reduce interference between analog signals and to improve computational reliability.

Second, it is possible to enhance computational latency and processing bandwidth. By proposing a technique (BitSift-GEMV) capable of simultaneously processing data of the maximum length including the fixed number of ‘1’s using bit-level sparsity of input data, it is possible to reduce the latency caused by frequent data segmentation and to significantly improve the processing bandwidth. Through this, it is possible to provide excellent performance in large-scale data processing and real-time application.

Third, it is possible to enhance energy efficiency. By minimizing redundant operation and data transmission in an input processing and computational process, it is possible to significantly reduce energy consumption. In particular, through efficient data processing within fixed SAWL, it is possible to implement a low power design that provides high performance with lower energy consumption.

Fourth, it is possible to alleviate ADC requirements and to enhance hardware stability. It is possible to reduce the burden of high effective number of bits (ENOB) ADCs required in the conventional methods, and to enable stable operations even with a relatively simple ADC design. Through this, it is possible to reduce implementation complexity of an analog-mixed-signal-based system and to reduce hardware cost.

Fifth, it is possible to perform transformer-based model and DNN optimization. The present disclosure may efficiently process large-scale vector-matrix multiplication (GEMV) operations essential for a transformer-based model, and to effectively utilize bit-level sparsity characteristics found in most DNNs. It is possible to achieve high compatibility with the state-of-the-art technology, such as post-training quantization (PTQ) and to guarantee accurate computation results.

Sixth, it is possible to achieve scalability and applicability. The proposed SAWL_{D} controller and BitSift-GEMV controller may provide scalability that may process various input sizes and signal characteristics. This allows them to be employed in the wide field of applications, such as large-scale data processing, energy-constrained systems, and real-time computing environments.

The aforementioned methods may be provided in a computer program stored in computer-readable media to be executed on a computer. Here, the media may be to continuously store a computer-executable program or to temporarily store the same for execution or download. Also, the media may be various types of recording methods or storage methods in which single hardware or a plurality of hardware is combined and may be distributed over a network without being limited to a medium that is directly connected to a computer system. Examples of the media include a ROM, a PROM, an EPROM, an EEPROM, a flash memory (e.g., NAND/NOR), an SSD, a HDD, a magnetic tape, optical media (CD-ROM, DVD, and BD), magneto-optical media, a memory card, and a USB memory. The media refers to non-transitory media, and does not include a transmission signal itself or purely volatile memory (e.g., RAM).

The methods, operations, or techniques of the present disclosure may be implemented in various manners. For example, the techniques may be implemented by hardware, firmware, software, or combinations thereof. Those skilled in the art may understand that various exemplary logical blocks, modules, circuitries, and algorithm operations described in association with the disclosure herein may be implemented using electronic hardware, computer software, or combinations thereof. To clearly describe this interchangeability between hardware and software, various exemplary components, blocks, modules, circuitries, and operations are described above in terms of functions thereof. Whether such functions are implemented as hardware or implemented as software depends on design requirements imposed on the overall system and a specific application. Those skilled in the art may implement the aforementioned functions in various manners for each specific application, but such implementations should not be interpreted as deviating from the scope of the present disclosure.

In hardware implementation, processing units used to perform the techniques may be implemented using one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described herein, computer, or combinations thereof.

Therefore, various exemplary logic blocks, modules, and circuitries described in association with the present disclosure may be implemented or performed in any combination with a general-purpose processor, a DSP, an ASIC, an FPGA, or other programable logic devices, a discrete gate or a transistor logic, discrete hardware components, or devices designed to perform functions described herein. The general-purpose processor may be a microprocessor and, alternatively, the processor may be a conventional processor, a controller, a microcontroller, or a state machine. The processor may be implemented using a combination of computing devices, for example, a combination of a DSP and a microprocessor, a combination of a plurality of microprocessors, a combination of one or more microprocessors associated with a DSP core, and a combination of other components.

In firmware and/or software implementation, the techniques may be implemented as instructions stored in computer-readable recording media, such as a random access memory (RAM), a read-only memory (ROM), a non-volatile random access memory (NVRAM), a programmable read-only memory (PROM), an erasable programmable read-only memory (EPROM), an electrically erasable PROM (EEPROM), a flash memory, a compact disc (CD), and a magnetic or optical data storage device. The instructions may be executable by one or more processors, and may cause the processor(s) to perform specific aspects of the functions described herein.

Although the example embodiments are described as using aspects of the currently disclosed subject matter in one or more stand-alone computer systems, the present disclosure is not limited thereto and may be implemented in conjunction with an arbitrary computing environment, such as a network or a distributed computing environment. Also, aspects of the subject matter in the present disclosure may be implemented in a plurality of processing chips or devices, and a storage may be similarly affected across the plurality of devices. The devices may include PCs, network servers, and portable devices.

Although the present disclosure is described with reference to some example embodiments, various modifications and changes may be made without departing from the scope of the present disclosure that may be understood by those skilled in the art. Also, such modifications and changes should be understood to fall within the scope of the claims.

What is claimed is:

1. An operating method of a computing device for performing an analog-mixed-signal-based in-memory-matrix multiplication operation using an input vector having bit-level sparsity, the method comprising:
detecting the number of logical value ‘1’s within an input vector;
reconstructing the input vector into a plurality of partial input portions each including a preset number of logical value ‘1’s, based on the detected number;
activating wordlines equal to or less than the preset number in a memory array, and applying the partial input portions to the activated wordlines; and
performing a matrix-vector multiplication operation based on a current response of the memory array.

2. The method of claim 1, wherein the performing of the matrix-vector multiplication operation comprises:
generating an analog accumulation signal corresponding to a partial sum of the matrix-vector multiplication operation by accumulating the on-cell current or the off-cell current of memory cells corresponding to the activated wordlines in an analog manner;
converting the analog accumulation signal to a digital partial sum value; and
generating the result of the matrix-vector multiplication operation by accumulating the digital partial sum value in the digital domain according to at least one of a bit position and a weight of the input vector.

3. The method of claim 1, wherein the reconstructing of the input vector into the partial input portions comprises adding at least one logical value ‘1’ as dummy input if the number of logical value ‘1’s is less than the preset number for at least one of the partial input portions.

4. The method of claim 1, wherein the result of the matrix-vector multiplication operation is implemented to be applied to post-training quantization (PTQ).

5. The method of claim 1, wherein the method is applied to a transformer-based model and a deep neural network (DNN).

6. The method of claim 1, wherein the set number for the wordlines is determined based on a reference value for suppressing the increase in the nonlinear distribution of analog signals, the signal deviation according to process, voltage, temperature (PVT) variations, and the increase in the distribution of on-cell current.

7. The method of claim 1, wherein the memory array includes skewing-based weight mapping, and the set number for the logical value ‘1’ is determined to compensate for the on-cell bias due to the skewing.

8. The method of claim 3, wherein a region of the memory array to which the dummy input is applied includes dummy cells storing a weight state that does not generate a current response to not influence the result of the matrix-vector multiplication operation.

9. A computing device for performing an analog-mixed-signal-based in-memory-matrix multiplication operation using an input vector having bit-level sparsity, the computing device comprising:
a memory; and
a processor configured to connect to the memory and to execute at least one instruction stored in the memory,
wherein the processor is configured to,
detect the number of logical value ‘1’s within an input vector,
reconstruct the input vector into a plurality of partial input portions each including a preset number of logical value ‘1’s, based on the detected number,
activate wordlines equal to or less than the preset number in a memory array, and apply the partial input portions to the activated wordlines, and
perform a matrix-vector multiplication operation based on a current response of the memory array.

10. A non-transitory computer-readable recording medium storing a computer program to execute a method of performing an analog-mixed-signal-based in-memory-matrix multiplication operation using an input vector having bit-level sparsity on a computing device, wherein the method comprises:
detecting the number of logical value ‘1’s within an input vector;
reconstructing the input vector into a plurality of partial input portions each including a preset number of logical value ‘1’s, based on the detected number;
activating wordlines equal to or less than the preset number in a memory array, and applying the partial input portions to the activated wordlines; and
performing a matrix-vector multiplication operation based on a current response of the memory array.
